(19) United States
(12) Patent Application Publication
(10) Pub. No.: US 2020/0340544 A1
(43) Pub. Date: Oct. 29, 2020

(54) COMPONENT FOR ABSORBING IMPACT FORCE

(71) Applicant: TEIJIN CARBON EUROPE GMBH, Wuppertal (DE)

(72) Inventors: Bernd WOHLMANN, Düsseldorf (DE); Christian HUNYAR, Wuppertal (DE); Markus SCHNEIDER, Düsseldorf (DE)

(21) Appl. No.: 16/759,873

(22) PCT Filed: Oct. 26, 2018
(86) PCT No.: PCT/EP2018/079466

§ 371 Date: Apr. 28, 2020

(30) Foreign Application Priority Data
Oct. 30, 2017 (EP) 17199076.5

(51) Int. Cl. F16F 7/12; F16F 7/00; C08J 5/04

(52) U.S. Cl. CPC F16F 7/124; F16F 7/003; C08J 5/042; B60R 19/34; F16F 2234/00; F16F 2236/04; F16F 2224/0241

(57) ABSTRACT

A component in the form of a crash element is made of a fibre composite material, the wall of which is constructed at least predominantly from bundles of carbon fibres. The carbon fibre filaments are arranged parallel to one another within the fibre bundles, and the bundles are embedded in a polymer matrix. Within the wall of the component the bundles are distributed uniformly and have a substantially isotropic orientation as considered perpendicularly to a first and/or second surface.

The invention relates to a three-dimensional body-shaped component made of a fibre composite material for arrangement between a first impact element and a second impact element and for absorbing impact energy as a result of an impact load acting between the first and second impact element.

The protection of vehicle occupants of a motor vehicle and the protection of people and objects in the vicinity of the vehicle in the event of a collision is an important aspect in the design and manufacture of a motor vehicle. In the case of a safe design of a motor vehicle in the event of a collision, it is important that a vehicle deceleration or a force which acts on the vehicle occupants while occupant restraint systems are in effect does not exceed certain threshold values in the course of the collision. In the event of a collision of the motor vehicle, there is a relationship between an effective mass of the colliding vehicle, a deceleration of the colliding vehicle and a force, in which a body structural support, which is often also referred to in this context as a crash structure or deformation element, progressively fails due to plastic, elastic deformation or brittle fracture. Such a deformation element can be attached, for example, between a bumper crossmember and a frame side member of the motor vehicle.

A possible reduction of the collision energy by the deformation element is determined by a force curve over an available deformation path. At the start of a collision, the vehicle's speed is high, so that a relatively high kinetic collision energy or impact energy has to be reduced and the body structure including a body structural support or deformation element has to be designed in such a way that the body structural support fails with an adapted level of force.

Body structural supports or deformation elements are often designed in such a way that they fail to absorb collision energy in the event of a collision load of the motor vehicle. Body structural supports made of metallic materials are designed in such a way that they plastically deform at a certain force level over a specified distance.

Body structural supports are widespread which use metal pipes that are compressed in the longitudinal direction in the event of an impact. The metal tubes, for example aluminium tubes, ensure a strong connection between the bumper crossmember and the vehicle. However, the specific energy absorption (kJ/kg) of metal pipes when compressed is not particularly high. Furthermore, the initial force required to compress a metal pipe in the longitudinal direction may be too great for many situations.

In the case of a body structural support or deformation element made of carbon fibre-reinforced plastic or another fibre-reinforced plastic, for example, hollow profiles have been proposed which have, for example, a rectangular profile. Such a hollow profile made of carbon fibre reinforced plastic fails due to so-called “crushing”. In the “crushing” failure mechanism, the body structural support is disintegrated to a greater or lesser extent (pulverisation or fragmentation, also known as splintering), primarily in the brittle fracture. This failure mechanism functions particularly in the event of a frontal impact, in which the force on the carrier is perpendicular to a cross-section of the carrier. The amount of force occurring in this failure mechanism per surface of the deformation profile cross section in the plane perpendicular to the direction of force is referred to as the crash failure stress.

Documents DE 102012019923 A1, DE 102014016024 A1, DE 102014206610, or EP 1366960 B1 disclose components for energy absorption or for the absorption of impact energy made from fibre composite materials, in particular composite materials based on carbon fibres. These body structural supports or deformation elements can be produced, for example, by braiding, pultruding or winding or, as is described in EP 1366960 B1, by laminating a plurality of fibre layers, for example a plurality of fabric layers, onto one another, preferably starting from continuous fibres. The components for energy absorption described in the cited documents sometimes have a layered structure or laminate structure, but can also be made from discontinuous fibres according to DE 102014016024 A1 or contain regions with randomly oriented fibres, as is described in EP 1366960 B1. Overall, the components described in the aforementioned documents have a complex component structure. US 2005/0147804 A1 also describes elements for energy absorption, these elements having a layered structure of fibre layers made of bundled filament yarns. The fibres are arranged so that their direction of extension is parallel or oblique to the pressure load due to the impact, i.e. that the fibres have a component in the direction of the impact load. In addition, in the elements for energy absorption in US 2005/0147804 Al, the density of the fibres increases from one end of the element to the other.

JP 06-264949 describes elements for energy absorption which are made up of fibre-reinforced synthetic resins, into which short fibres are mixed. The elements for energy absorption in JP 06-264949 have a cylindrical shape, the wall of a cylindrical section being designed such that the wall thickness increases from one end to another end. In the examples, JP 06-264949 starts from elements produced by an injection moulding process with a polypropylene matrix into which glass fibres with a fibre length of 3 mm and in a concentration of 30 wt. % have been mixed.

Structures made of fibre composite materials with a thermoplastic matrix for shock absorption or for energy absorption are described in EP 3104036 A1. The structures are usually designed as hollow profiles and can have bundle-shaped reinforcing fibres. The fibres can be carbon fibres that are embedded in the thermoplastic matrix. The fibres can preferably be randomly oriented in two dimensions in a surface plane. To produce the fibre composite materials, reinforcing fibres can be cut, then opened and the opened reinforcing fibres can then be mixed with a fibrous or particulate thermoplastic. The mixture is then pressed under pressure and heat into a fibre-reinforced thermoplastic semifinished product. One or more such layers of semifinished products are stacked on top of one another in layers to form the hollow profile.

Because of the high viscosities of thermoplastic matrices, the uniform impregnation of the fibres with the thermoplastic matrix and the homogeneous distribution of the fibres in the matrix as the basis for uniform mechanical properties can be difficult during processing. In addition, the layered structure can lead to delamination of the layers in the event of an impact load in a direction parallel to the layers, combined with the detachment of large, contiguous material areas, which significantly reduces the specific absorption of impact energy, or in connection with the buckling of areas of the component weakened in this way, which leads to the sudden failure of the component and extremely low impact force absorption.

The object of the present invention is to provide a structurally simple and easy-to-manufacture component for energy absorption in the event of impact load. The component should have a high specific energy absorption when subjected to impact loads. In addition, in the event of an impact load in the component, the initial peak loads, as can be observed in particular in the case of deformation elements made of metallic materials, should be reduced and certain threshold values should not be exceeded in the course of the collision/impact load.

The object is achieved by a three-dimensional, body-shaped component made of a fibre composite material based on carbon fibres for arrangement between a first impact element and a second impact element and for absorption of impact energy as a result of an impact load, which has an impact direction, acting between the first and second impact element, wherein the component has
at least a first end and a second end,
a longitudinal direction extending between the ends, which can be arranged essentially in the direction of impact,
a first surface and a second surface and a wall with a wall thickness extending between the first and the second surface,
wherein the wall is at least predominantly composed of bundles of carbon fibres, within which the carbon fibre filaments making up the carbon fibres are arranged parallel to one another,
wherein the bundles and the carbon fibres making up the bundles are embedded in a polymer matrix, which predominantly comprises one or more crosslinked polymers,
wherein the bundles are distributed substantially uniformly over the wall thickness, are oriented essentially isotropically when viewed in a direction perpendicular to the first and/or second surface, and when viewed parallel to the first and/or second surface (8, 9) the bundles form intersection angles with a part of the first and/or second surface (8, 9), wherein the bundles are distributed parallel to the first and/or second surface (8, 9) within the component in such a way that the predominant portion of the intersection angles lies in a range in which the intersection angles are in the west evenly distributed between 0° and 90° towards predominantly present intersection angles that are greater than 1°.
wherein the fibre volume fraction of the carbon fibres in the wall is in the range between 35 vol. % and 70 vol. %,
wherein the bundles of carbon fibres have a length in the range between 3 mm and 100 mm and
wherein the component is obtainable by a method comprising the production of a fibre preform from the bundles of carbon fibres, and optionally by subsequently introducing a matrix system into the fibre preform by injection, infusion, infiltration or pressing.

The component should be designed as a body in a viewing direction parallel to the longitudinal extension. The term body includes both a profile, half profiles or other geometries, the cross section of which can change along the longitudinal axis. The body can be hollow, solid and/or partially filled and/or its longitudinal extension can be divided by means of intermediate pieces. Furthermore, the body can have different wall thicknesses, contain reinforcing elements and/or have recesses. The body that forms the component can be constructed from one piece (in one piece) or from a plurality of partial bodies. The partial bodies can likewise have different cross sections, be hollow, solid and/or partially filled, and have different wall thicknesses and/or geometries.

The component can also be referred to as a deformation element. The bundles of carbon fibres can also be referred to as carbon fibre bundles, reinforcing fibre bundles or just as bundles.

The component can also be formed without the subsequent introduction of the components of a matrix system (for example a duromer matrix resin). In this embodiment, the fibre bundles and thus the component itself already have so much polymer matrix that an additional introduction of matrix material (a matrix system) is not necessary for component production. In such a case, the component can be produced, for example, by activating the components of the polymer matrix using pressure and heat.

The polymer matrix (in which the fibre bundles are embedded) predominantly consists of one or more crosslinked polymers. To a lesser extent, the polymer matrix can also have a minor portion of partially crosslinked polymers. For example, the polymer matrix can have a predominant portion of a fully crosslinkable duromer and a minor portion of a thermoplastic resin system and/or additives. Thermoplastic duromers are preferably used. In another embodiment, the polymer matrix consists of a conglomerate of epoxy with thermoplastic portions.

In the optional embodiment, the matrix system is preferably a polymer matrix system which predominantly consists of one or more crosslinked polymers (for example a duromeric matrix resin). For component production, the matrix system preferably cures. The matrix system (which can optionally be added in addition to component production) preferably also consists predominantly of one or more crosslinked polymers. To a lesser extent, the matrix system can have fully or at least partially crosslinked polymers. For example, the matrix system can have a predominant portion of a fully crosslinkable duromer and a minor portion of a thermoplastic resin system and/or additives. Thermoplastic duromers can also be used. In a further embodiment, the matrix system consists of a conglomerate of epoxy with thermoplastic portions.

By selecting the polymer matrix and the matrix system, the component advantageously has approximately constant properties over a large temperature range. Temperature-dependent fluctuations in energy absorption (such as occur, for example, when using thermoplastics) can advantageously be avoided.

If one considers a theoretical linear extension of the fibre bundles beyond the first and/or second surface of the component, this line forms angles with the first and/or second surface of the component. When considering a sufficiently small and flat area of the first and/or second surface of the component (part of the first and/or second surface), the majority of the bundles between the first and/or second surface form so-called intersection angles with the first and/or second surface. The intersection angles of the fibre bundles lie in a range in which the intersection angles are in the west evenly distributed between 0° and 90° up to an arrangement of the fibre bundles in which the intersection angles predominantly have an angle of greater than 1°, preferably greater than 2° and most preferably have greater than 3°. With a distribution of the fibre bundles that is predominantly isotropic when viewed parallel to the first and/or second surface, the intersection angles essentially all have a value between 0° and 90°, whereby no value should be represented much more often or less often. If the fibre bundles are relatively parallel to the first and/or second surface, the predominant portion of the fibre bundles have intersection angles that are greater than 1°. As a result, the majority of the fibre bundles is essentially not exactly parallel to the surfaces of the component in the component. It should be made clear that the fibre bundles can assume any arrangement within the defined range, wherein the majority of the fibre bundles within the component, however, have the selected arrangement.

A “predominant portion” should be understood to mean a portion of approximately 70% to 100%, preferably 80% to 95% and most preferably 85% to 90%.

The expression “essentially all” means that this applies to 80% to 100%, preferably 85% to 95%.

The fibre bundles are, for example, isotropic in the component and also isotropic with regard to the surfaces if the fibres of the fibre bundles are short and the wall thickness of the component is greater than the fibre length. An example of this could be the use of fibre lengths of 3 mm for a component with a wall thickness of 5 mm. A non-isotropic distribution of the intersection angles between the bundles of carbon fibres and the surfaces of the component, in which the intersection angles of the predominant portion of the bundles are greater than 1°, results in particular when the fibre length of the bundles is relatively large in relation to the wall thickness, for example with a fibre length of 50 mm and a wall thickness of 2 mm. Since the component can have different bundles with different fibre lengths and, in addition, different wall thicknesses within a component or also are conceivable with different components, the arrangement of the bundles parallel to the surfaces fluctuates between these two possibilities.

The extension of the component in the longitudinal direction is preferably greater than its extension perpendicular to the longitudinal direction.

The three-dimensional, body-shaped component made of a fibre composite material according to the invention can be between a first impact element and a second impact element, thus, for example, between a bumper crossmember and a frame side member of a motor vehicle, and absorb impact energy in the event of a collision or in the event of an impact load acting between the first and second impact element. This shows that the component according to the invention leads to a uniform absorption behaviour, which can be seen from the force curve over the deformation path, wherein the peak loads in the initial phase of an impact load are comparatively low. At the same time, a high specific energy absorption (kJ/kg) can be achieved with the component according to the invention in comparison to components or deformation elements made of metallic materials.

The component according to the invention thus provides a solution which enables defined energy absorption at a level which is as constant as possible over an adjustable long deformation path. The actual energy level can be set, inter alia by the geometrical design of the component (especially by the wall thickness). In addition, the isotropic material structure of the component offers a defined, constant energy absorption even with impact loads that do not run axially to the longitudinal expansion of the component.

A comparable or higher level of specific energy absorption is also shown in comparison to deformation elements made of fibre composite materials, which have a layered structure of layers of a fibre composite material laminated on top of one another. In the case of failure, with components or deformation elements having a layered structure, the layers are at least partially delaminated, i.e. the layers are peeled or broken apart, accompanied by a lower resulting force level. In contrast to such components or deformation elements with a layered structure, such a failure cannot take place in the present component or deformation element, since when viewed in a direction perpendicular to the thickness of the wall or parallel to the first and/or second surface of the component, the majority of the bundles are arranged between an isotropic alignment and an alignment in which the bundles essentially do not fall below an intersection angle greater than 1° to the first and/or second surface of the component. This means that there is no layered structure, but penetration of different levels of the wall of the component by the bundles, that is, an entanglement of the fibre structures.

Finally, the distribution of the bundles, which is essentially uniform over the wall thickness, and in particular their essentially isotropic alignment when viewed in a direction perpendicular to the first and/or second surface, ensures that in the event of an impact load, uniform failure without peak loads occurs in the initial phase of an impact load.

Without wishing to be bound by theory, it is assumed that the fact that the fibre composite material and thus the wall of the component according to the invention is at least predominantly made up of bundles of carbon fibres and the orientation of the fibre bundles required according to the invention is the cause of a high specific energy absorption. In the event of an impact load and a resulting failure of the component in the failure zone initiated thereby the impact energy is dissipated from the continuously acting impact force in such a way that it is converted into degradation energy to generate new surfaces between the fibres and the matrix. Due to the reinforcing fibre structure of the fibre composite material according to the invention, which not only has an isotropy parallel to the component surface, but also ensures a strong entanglement of the fibre bundles through the thickness, a high degradation energy density, and thus a high specific energy absorption, can be guaranteed as the failure zone progresses over the entire component volume.

Likewise, the high fibre volume fraction of the carbon fibres in the wall in the range between 35 vol. % and 70 vol. % is the reason for a high specific energy absorption of the component under impact load. It should be noted that with fibre volume fractions below 35 vol. %, the failure behaviour of the component under impact load is dominated by the matrix failure, i.e. the failure behaviour is determined by a break or crack in the matrix and thus by an intermediate fibre break. In the case of fibre volume fractions above 35 vol. %, the failure behaviour is primarily determined by a failure at the interface between the fibre and the matrix, i.e. by a fibre break. The higher failure forces of the latter two failure modes compared to the first failure mode generate a high degradation energy density and thus a high specific dissipated energy and thus a high specific energy absorption in the material. Above 70 vol. %, on the other hand, a sufficient distribution of the matrix in the component and wetting on the filament surfaces of the fibre bundles can no longer be ensured. It is also assumed that the fibre volume fraction at very high values is limited by the filament geometry, since in the case of circular filament cross-sections a densest circular packing in the cross-sectional plane along the fibre direction in the fibre bundle cannot be exceeded. Above 70 vol. % this fibre volume fraction ensures a poor fibre matrix connection and thus a low specific energy dissipation in the component. In a preferred embodiment of the component according to the invention, the fibre volume fraction of the carbon fibres in the wall of the component is in the range from 45 vol. % to 65 vol. %.

According to the invention, the bundles of carbon fibres, i.e. the reinforcing fibre bundles, consist of carbon fibre filaments aligned parallel to one another and have a length of between 3 mm and 100 mm. The length is preferably in the range from 5 mm to 70 mm and most preferably in the range from 10 mm to 50 mm. With a view to the attainable fibre volume fractions of carbon fibres in the wall of the component, in particular in order to achieve portions above 45 vol. %, it is advantageous if the wall of the component according to the invention has several groups of reinforcing fibre bundles with lengths that differ from one another, so that the length of the reinforcing fibre bundles has a distribution overall. For example, reinforcing fibre bundles with a length of 20 mm, 30 mm and 50 mm can be combined with one another.

The bundles of carbon fibres, i.e. the reinforcing fibre bundles, can consist of conventional carbon fibre filament yarns with, for example, 500 to 50,000 fibre filaments. However, it is advantageous if each reinforcing fibre bundle consists of 500 to 24,000 reinforcing fibre filaments. The number of filaments in the bundles is most preferably in the range from 500 to 6,000 and very preferably in the range from 1,000 to 3,000 in order to achieve the most homogeneous possible distribution of the reinforcing fibre bundles in the component wall and to achieve the highest possible fibre volume fractions.

In one embodiment, a multifilament reinforcing yarn can be used as a carbon fibre yarn with a strength of at least 5000 MPa measured according to JIS-R-7608 and a tensile modulus of at least 260 GPa measured according to JIS-R-7608.

In order to achieve high fibre volume fractions in the component wall, in particular to achieve portions of carbon fibres above 45 vol. %, it has also proven to be advantageous if the wall has several groups of reinforcing fibre bundles with different numbers of filaments, since this results in high packing densities of the bundles in the wall. For example, reinforcing fibre bundles with 3,000, 6,000 and 12,000 filaments can be combined.

In order to achieve the required fibre volume fractions in the wall, the bundles that form the wall of the component according to the invention preferably have a width in the range from 1 mm to 20 mm and most preferably a width in the range from 1 mm and 10 mm. Likewise, in order to achieve high packing densities of the bundles, that is to say to achieve high fibre volume fractions in the component wall of above 45 vol. %, it is also advantageous if the bundles have a cross section that is as flat as possible perpendicular to the extent of the carbon fibre filaments in the bundle. The bundles are preferably in the form of a band and have a ratio of bundle width to bundle thickness of at least 25. The ratio of bundle width to bundle thickness is most preferably in the range from 30 to 150.

Through a suitable selection of reinforcing fibre bundles with regard to their ratio of bundle width to bundle thickness, with regard to their length and with regard to the number of reinforcing fibre filaments, particularly high packing densities of the reinforcing fibre bundles and thus particularly high fibre volume fractions in the component wall can be achieved. In a very particularly preferred embodiment of the component, the bundles arranged in the wall of the component have, in addition to a flat cross section, different lengths and different numbers of filaments. This leads to particularly high fibre volume fractions in the wall of the component.

For the use of the component according to the invention for the absorption of impact energy, i.e. as a deformation or crash element, a uniform material behaviour over the widest possible range of environmental conditions, such as temperature or humidity, is required. Depending on the manufacturer and area of application, different continuous operating temperatures apply to applications in the automobile. A temperature window of −40° C. to 120° C. has been established for applications in areas close to the engine or exhaust system. The glass transition temperatures of most thermoplastics that are relevant for automotive engineering are in this temperature range. For example, the glass transition temperatures of the polyamides widely used in the automotive sector are in the range of approx. 35° C. and 60° C. Such thermoplastics are consequently difficult to use in a component for absorbing impact energy with the same properties.

Of course, there are also thermoplastics with higher glass transition temperatures, for example thermoplastics from the PAEK family, such as polyether ether ketones (PEEK) etc. However, these matrix materials are too expensive for applications in large series in the automotive industry. On the one hand, the costs of the materials are too high, on the other hand, the high processing temperatures due to the high melting temperatures mean considerable follow-up costs. Thermoplastics with a melting point above 250° C. (preferably 220° C.) are not suitable. In addition, all matrix materials which have a water absorption of greater than 5 wt. %, preferably greater than 3 wt. %, are unsuitable for structural components in a vehicle. With increasing water absorption, the components swell and the mechanical performance decreases. Consistent properties, for example constant energy absorption values, cannot therefore be achieved with changing environmental conditions.

The bundles in the component and the carbon fibres making up the bundles are therefore preferably embedded in a polymer matrix, which predominantly consists of one or more partially or fully crosslinked polymers. The polymer matrix preferably consists of at least 60 vol. %, based on the matrix fraction, and most preferably at least 75 vol. %, of one or more partially or fully crosslinked polymers. Other components of the polymer matrix can be thermoplastics, for example, in order to increase the impact resistance of the component or other additives which, for example, influence the processability or the service life of the component. In an advantageous embodiment, the polymer matrix has a matrix material based on acrylate or methacrylate. In addition, polyester resins, vinyl ester resins or phenol-formaldehyde resins can be contained in the polymer matrix.

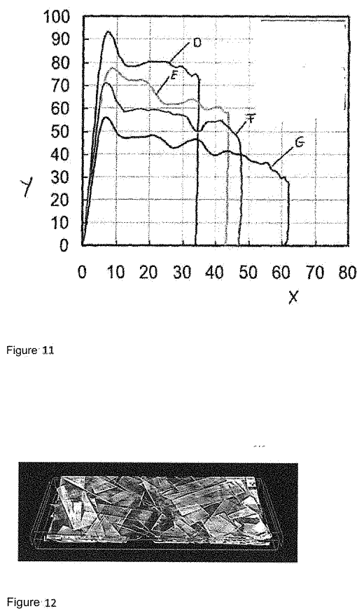

The carbon fibres in the wall of the component are preferably stretched when viewed perpendicular to the first and/or second surface of the wall (see FIG. 12).

As stated, the wall is at least predominantly made up of bundles of carbon fibres, within which the carbon fibre filaments that make up the carbon fibres are arranged parallel to one another, wherein the bundles and the carbon fibres making up the bundles are embedded in a polymer matrix, which predominantly consists of one or more crosslinked polymers. This means that the bundle structure in the finished component is actually preserved. Advantageously, the carbon fibres are stretched in the bundles, as a result of which a high level of compressive rigidity values can be achieved for the component according to the invention.

This property of the component according to the invention is advantageous in application because, when the component or the deformation element is subjected to an impact load, which causes the component to fail while forming a crash zone, the material located below the crash zone must withstand the compressive forces and must not fail. This high pressure rigidity is necessary because it keeps the deformation in the support zone not yet damaged by failure (crushing) low and thus prevents the premature failure of the component due to buckling. If the compressive stiffness is comparatively low in relation to the crash failure stress, the component would otherwise have to be made very thick or, in the worst case, it would always fail due to buckling processes.

In the context of the present invention, a stretched configuration of the carbon fibres in the component is understood to mean that the carbon fibres are not bent or buckled by themselves and that a change in the longitudinal extension of the carbon fibres is only due to the geometry of the component. The fibre bundles therefore have no buckles or corrugations either in the longitudinal extension or transversely to the longitudinal extension, which would not be caused by the geometry of the component.

In conventional fibre composite materials, such as those based on fabrics, nonwovens or sheet moulded compounds (SMC), the fibres are curved or undulating, so that the stiffness values (modulus of elasticity) for tensile and in particular for compressive loads are reduced. These reduced properties are disadvantageous for both static and dynamic loads. Such curved or corrugated arrangements of the fibres can be made visible, for example, by means of X-ray examinations. For example, the Handbuch der Faserverbundwerkstoffe/Composites, Springer Verlag, 2014, 4^{th} Edition, page 253 in FIG. 154 or page 270 in FIG. 270 shows the X-rays of an SMC component. The reinforcing fibres were oriented and undulated in the manufacture of the SMC component during the filling process by the flow of the viscous matrix. The fibre bundles are not aligned along a straight line, but have a clear curvature in comparison. In addition, the strong flow of the matrix and fibres creates an inhomogeneous fibre distribution during the filling process.

In comparison, the carbon fibre bundles according to the invention are distributed homogeneously over the component cross section. In the present case, a homogeneous distribution is understood to mean that the fluctuation in the fibre volume fraction is less than ±10 vol. % for each sample of the component with a size of at least half the fibre bundle length of the component (for example for a cylindrical sample of 25 mm in diameter and 2 mm thickness with a component wall thickness of 2 mm and a fibre bundle length of 50 mm). In addition, the bundles are already stored in essentially the final geometry when the preform is manufactured. Only the flowable components of the polymer matrix are added during the injection and infusion process. A displacement of the carbon fibre bundle is excluded due to the fixing of the preform. Additionally, the carbon fibre bundles keep their stretched orientation. In this way, high compressive rigidity values are achieved and undesired failure at weak points, such as resin-rich zones or particularly strongly deformed areas of the component, is avoided.

The component can be manufactured in a simple manner by first producing a fibre preform, often also referred to as a preform, from the bundles of carbon fibres. The fibre preform, which is already close to the final contour, is placed in a tool which has the negative or positive shape of the component close to the final contour. If the reinforcing fibre bundles already have enough matrix material, the addition of further matrix material is not necessary. In such a case, the matrix material can be activated with pressure and heat, for example for component production. However, it can also be provided that additional matrix material (matrix system) is supplied to the fibre preform by means of conventional methods. For example, the matrix material, i.e. the matrix resin which has not yet been fully or partially hardened, can be introduced into the tool and thus into the fibre preform via infusion, infiltration, injection or pressing. The component is then formed with full or partial crosslinking of the polymeric matrix material (for example by curing a duromeric matrix resin).

The fibre preform can be produced inexpensively and in a simple manner by the method as described, for example, in EP 2727693 B1, the disclosure of which is expressly incorporated by reference. The method of EP 2727693 B1 comprises the following steps:
Feeding at least one endless band-shaped strand of reinforcing fibres provided with a binder from a template onto a placement head, wherein the at least one strand has a strand width of at least 5 mm, and a concentration of the binder in the range from 2 wt. % to 20 wt. %, alternatively from 15 wt. % to 75 wt. %, based on the weight of the band-shaped strand.
Spreading the at least one endless band-shaped strand in a spreading unit arranged on the placement head and conveying the at least one strand in the conveying direction by means of a first conveying device arranged on the placement head to a longitudinal separating device arranged on the placement head, thereby stabilising the at least one strand in the direction transverse to the conveying direction,
Cutting the at least one strand into two or more partial strands in the longitudinal separating device along its longitudinal extension by means of at least one separating element,
Conveying the partial strands in the conveying direction by means of a second conveying device arranged on the placement head to a cutting unit arranged on the placement head,
Cutting the partial strands using the cutting unit into reinforcing fibre bundles of defined length and
Depositing the reinforcing fibre bundles on a surface and/or on reinforcing fibre bundles deposited on the surface and fixing the reinforcing fibre bundles on the surface and/or on reinforcing fibre bundles deposited on the surface to form the fibre preform, wherein a relative movement between the placement head and the surface is set for the load-appropriate placement of the reinforcing fibre bundles on the surface.

Bundles of carbon fibres in which the carbon fibres are provided with a binder are preferably used to produce the fibre preform. This binder is a material by means of which the fibre preform can be brought into a stable state, for example by heat activation and subsequent cooling, which allows the fibre preform to be handled in subsequent process steps.

The binder can then be a fibre preparation, as is usually applied to the filaments of the carbon fibres, in order to achieve improved processability and good fibre closure, that is to say an at least partial connection of the filaments to one another. Such preparations are often based on epoxy resins or polyurethane resins. The polymer matrix (in which the fibre bundles are embedded) preferably represents the binder or the preparation for the carbon fibre bundles. For the production of the fibre preform for the component according to the invention, however, an increased content compared to the commonly used concentrations of the preparation is required, preferably in the range from 2 wt. % to 14 wt. % and most preferably in the range from 3 wt. % to 7 wt. %, based on the total weight of the carbon fibre yarn provided with binder.

Suitable binders here are thermoplastic or uncured or partially cured duromeric polymers or polymer compositions composed of these polymers. Suitable thermoplastic polymers are, for example, polyethyleneimine, polyether ketone, polyether ether ketone, polyphenylene sulphide, polysulfone, polyether sulfone, polyether ether sulfone, aromatic polyhydroxy ethers, thermoplastic polyurethane resins or mixtures of these polymers. Examples of suitable uncured or partially cured thermosetting polymers are epoxies, isocyanates, phenolic resins or unsaturated polyesters.

It is advantageous if the carbon fibres provided with the binder or the carbon fibre bundles are not tacky at processing temperatures such as those used to produce the fibre preform, that is to say when the bundles are deposited on the fibre preform, that is to say generally at room temperature. At elevated temperatures, however, the binder or the carbon fibres provided with the binder should be tacky and lead to good adhesion of the fibre bundles produced therefrom. Such reinforcing fibre yarns or strands of reinforcing fibres are described, for example, in WO 2005/095080, the disclosure of which is expressly referred to here. The filament yarns there are infiltrated with a binder composed of several different epoxy resins, wherein these epoxy resins differ from one another in a defined manner in terms of their properties, such as epoxy value and molecular weight, and in terms of their concentration. WO 2013/017434, the disclosure of which is expressly referred to, also describes carbon fibres preimpregnated with a binder.

In an advantageous embodiment of the component according to the invention, the polymer matrix and/or the matrix system used in the component has a fracture toughness which increases by a maximum of 100% when the temperature changes from 20° C. to 100° C., measured according to ISO 13586. Components with such a matrix property have a high matrix brittleness. (The more brittle the matrix, the lower the fracture toughness.)

It is assumed that by selecting the matrix material with such a fracture toughness, the component delaminates when force is applied to the individual fibre bundles, as a result of which a large inner surface is formed in the component, which contributes to the eventual conversion of the collision energy into heat. The polymer matrix used in the component can be the polymer matrix of the reinforcing fibre bundle and/or the matrix system optionally added for the production of the component.

As stated, the component is designed as a body in a viewing direction parallel to the longitudinal direction. By designing as a body, a self-supporting structure that is stable against buckling loads is obtained. In this way, the impact energy can be dissipated evenly over the deformation path and buckling of the component, which ends further energy dissipation, can be at least largely avoided.

In a preferred embodiment, when viewed parallel to the longitudinal direction of the component, the body can be a profile, more preferably a corrugated profile, a zig-zag profile, an angle profile or a profile which has a mixture of the aforementioned profiles. However, it can also be any, even irregular, profiles. The inner and/or outer cross section of the body preferably has a corrugated shape, a zig-zag shape, an angular shape, a curve or a mixture of the aforementioned shapes.

In a further preferred embodiment, the component can have a closed hollow profile as a body, which has a cavity extending between the first and second ends, wherein the first end and the second end are connectable to the first and second impact elements, and wherein the hollow profile has an outer and an inner cross section and the first surface faces away from the cavity and the second surface faces towards the cavity. Hollow profiles are preferred in which the inner and/or the outer cross-section has a circular, elliptical, square or rectangular contour or a polygonal contour. Examples of such hollow profiles can be found, for example, in EP 3104036 Al or also in US 2005/0147804 A1.

The component can have more than one first and one second end. For example, the component can have three or more ends. To simplify matters, a first and a second end are referred to below, without the component being restricted to these.

In a preferred embodiment, the wall thickness of the component according to the invention is constant over the extension in the longitudinal direction (see FIG. 2c). In a further preferred embodiment, the wall thickness of the component increases from the first to the second end of the component (see FIG. 2d). In the case of a hollow profile as the body of the component, the inner and/or the outer cross section can preferably be constant along the extension in the longitudinal direction. Likewise, in the case of a component with a hollow profile as the body, the inner and/or the outer cross section can preferably increase in a region between the first and the second end from the first to the second end of the composite-material component.

In the event that the inner and outer cross sections are constant, a wall with a wall thickness constant from the first to the second end of the component is obtained. In this embodiment, the cross-sectional area of the wall is also constant over the extension of the component in the longitudinal direction. Likewise, a constant wall thickness can be obtained if the inner and outer cross sections increase in the same way along the extension in the longitudinal direction from the first to the second end. In this case, however, the cross-sectional area of the wall increases over the extension of the component in the longitudinal direction from the first to the second end of the component. Further advantageous embodiments of the component according to the invention are those in which the wall thickness increases in a range between the first and the second end from the first to the second end of the component. Further designs of the component provide that the wall of the component is only thicker and/or thinner in partial areas. Partial areas, whose wall is thicker within the partial area can have ribs, for example. Partial areas whose wall is thinner within the partial area can, for example, be trigger areas which can be used to apply force.

The component is preferably constructed from a plurality of partial bodies. For example, the component can consist of two body shells which, when put together (for example by means of connection by flanges), form the component. In the final application (for example in the vehicle), the component can be used individually or with several components as an absorption element for impact energy. When using a plurality of components, the components used can be constructed identically or differently and/or can be arranged in a row next to one another, one above the other and/or concentrically around a centre point.

In a preferred embodiment, in the event that the component as a body is a closed hollow profile, this component is constructed from two partial profiles which are connected to one another in the longitudinal direction to form the hollow profile. Such partial profiles, for example in the form of half-shells, can be produced in a particularly simple manner by means of a process for producing a fibre preform or a preform, since the reinforcing fibre bundles can be placed in an open form during the manufacture of the preform. The partial profiles preferably have lateral flanges in the longitudinal direction, by means of which the partial profiles are connected to one another. The connection can preferably be made using an adhesive, for example using a 2-component construction adhesive. The connection can also be made by means of a clamping, screwing, welding and/or riveting surrounding the flanges or by means of an auxiliary construction surrounding the flanges, as described for example in EP 3104036 A1. The partial profiles are preferably connected to one another in a positive and/or non-positive manner.

It is advantageous if the component has at least on its first and/or second end an area for introducing the impact energy. When using the component according to the invention, it is important that, in the event of an impact load, a failure zone is formed in a controlled manner, with as much energy as possible being absorbed by the component as it progresses. This can advantageously be achieved in that the impact force or impact energy is first introduced into the component, which is often also referred to as a crash element, into an area at the end of the crash element for introducing the impact energy, the so-called trigger area, which, for example, can be a sloping section of the cross-sectional area (chamfer). The precise geometric design of this area has proven to be less important. However, it must include a reduction in the wall thickness or the cross-sectional area of the wall and is above all a predetermined breaking point for targeted failure. An increased tension acts in the trigger area, since the same force acts on less material in the area of the bevelled tips, and the material fails.

According to the invention, the wall of the present component is constructed at least predominantly from bundles of carbon fibres, within which the carbon fibre filaments that make up the carbon fibres are arranged parallel to one another. In a preferred case, however, the wall can additionally comprise at least one layer of unidirectionally oriented long fibres, wherein the at least one layer can be arranged on at least one of the surfaces or in the interior of the wall and extend between the first and the second end of the component. Such layers of unidirectionally oriented long fibres can be used, for example, to further stabilise the component against buckling. The long fibres preferably extend from the first to the second end of the component. If there are more than two ends, the long fibres preferably extend between at least two ends of the component. Such long fibres preferably have fibres with a length of more than 10 mm and a width of more than 3 mm.

In an advantageous embodiment of the component according to the invention, the wall on the first and/or second surface has reinforcing elements which extend in the direction of the longitudinal direction of the component. Such reinforcing elements can have, for example, the shape of ribs or lamellae which are applied to the surface, for example by gluing separately manufactured elements (see also FIG. 2). The reinforcing elements can also consist of fibre composite material, but they can also be elements made of metallic materials, for example. In the event that the reinforcing elements consist of fibre composite material, the reinforcing elements can also be integrally connected to the component or the wall of the component and produced together with the wall. For example, bands of unidirectional fibres such as, for example, unidirectional prepregs can be laminated onto the wall of the fibre preform and, after the matrix material has been injected, can be cured to form the component together with the fibre preform provided with the matrix. However, the reinforcing elements preferably consist of the same bundles of carbon fibres that were also used to form the wall of the component.

In a further preferred embodiment, a permanently load-bearing element is integrated into the component, which can be connected to the first or the second impact element.

In the event of an impact load, this permanently load-bearing element is not destroyed together with the component, but rather shifted and/or deformed. Such elements can be used to ensure that a connection remains between the first and the second impact element even after the component has been destroyed after an impact load, that is to say, for example, the bumper crossmember is still held on the frame side member of the motor vehicle. For example, the permanently load-bearing element can be a steel tube that is telescopically displaced in the component in the event of a crash or in the event of an impact load. It is also possible for several permanently load-bearing elements to be integrated into the component.

The invention is described below by means of examples, wherein the examples and figures represent merely embodiments of the invention and are not to be understood as restrictive.

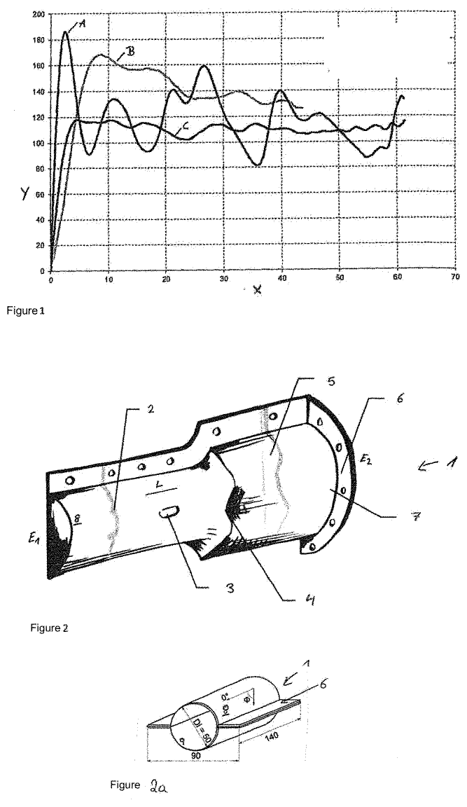

FIG. 1 schematically shows a comparison of the voltage-path profiles between components not according to the invention and an exemplary embodiment of the component according to the invention in a crash.

FIGS. 2, 2a, 2b, 2c and 2d schematically show possible embodiments of the component. FIGS. 1 and 3 to 11 show various crash data in curves for exemplary embodiments of the component. The X axis respectively represents the path measured in mm. The Y axis indicates the force measured in kN.

FIG. 1 shows a comparison of the pressure or stress-displacement profiles of an aluminium component (curve A) compared to components made of fibre-reinforced plastics. The X axis describes the path in mm, the Y axis the pressure or stress in MPa. The components made of fibre-reinforced plastics are an example of a thermoplastic material with carbon fibres (curve B) and a component, according to an exemplary embodiment of the invention (curve C), which is not according to the invention, wherein the carbon fibres with an average cut length of the fibre bundles of 50 mm are present in an isotropic fibre bundle distribution in the component. Both components made of fibre-reinforced plastic had the same geometry and were made up of half shells. The aluminium component consisted of a tube with an inner diameter of 66 mm and a wall thickness of 2 mm. The geometries of the components have been coordinated so that the results are comparable.

It can be seen that the amplitude fluctuation in relation to the path of the aluminium component is much more pronounced than the amplitude fluctuations in the components made of fibre-reinforced plastics. In comparison to the component made of fibre-reinforced plastic not according to the invention, the initial stress amplitude of the failing component according to one exemplary embodiment of the invention is significantly lower. As a result, kinetic energy is already converted into deformation energy at lower initial forces, and the following vehicle structures or vehicle occupants are protected, for example, from the effects of high forces.

FIG. 2 shows an exemplary embodiment of a component 1 that can be used for impact energy absorption. The component 1 has a first end E1 and a second end E2 and, for example, a semicircular cross section, wherein the cross-section changes along the longitudinal direction L. The component 1 can have a rib 2 (or a plurality of ribs), which can be provided, for example, on a first surface 8. The rib can be made in one piece from the component 1 or can be attached to component 1 as a further element. For example, the rib 2 can be formed by placement of one or more fibre bands on the component 1. The component 1 can furthermore preferably have recesses 3, such as holes. By means of these recesses 3, the weight of the component 1 can advantageously be reduced without reducing the length or width of the component 1. Flaps or covers 5 can be provided within the component, which subdivide the component 1 in its longitudinal extension L. The covers 5 can be designed such that they extend from one wall to the other wall and thus form a closure, or they can only extend inside the component 1 without the cover 5 having contact with the other (opposite) wall side. The lids or flaps 5 can advantageously stabilise the component 1 and, for example, prevent the body 1 from buckling in the event of an impact. In the exemplary embodiment in FIG. 2, the body 1 has a semicircular profile 7, wherein the first end E1 has a smaller diameter than the second end E2. The component 1 can be connected to other parts by means of flanges 6. The other parts can be, for example, further components 1 for absorbing impact energy (of the same type or of a different type) or can be impact elements. By means of the flanges 6, the component 1 can be positively and/or non-positively connected to the other parts, wherein an irreversible connection is preferred.

FIG. 2a shows an exemplary embodiment of component 1, as was used for example 1.

A section of the component 1 is shown schematically in FIG. 2b. A part of a wall of the component 1 with the first surface 8 is shown. When considering a perpendicular S to the first surface 8, fibre bundles for forming the component 1 are essentially isotropic. Furthermore, when considering a parallel W to the first surface 8, the fibre bundles form intersection angles to the surfaces 8, 9.

FIG. 2c schematically illustrates an embodiment of component 1 in a simplified manner. In this exemplary embodiment, an outer cross section 11 of the component at the first end E1 is smaller than the outer cross section 11 at the second end E2. The cross section of the component 1 has consequently increased over the longitudinal direction L. An inner cross section 11′ of the component 1 may have changed from the first to the second end E1, E2 or may have remained the same. With a constant inner cross section 11′, there is a change in the wall thickness of the component 1.

A further embodiment of component 1 is shown schematically in FIG. 2d in a simplified manner. In this exemplary embodiment, the outer cross section (not shown) of the component 1 remains constant from the first end E1 to the second end E2. However, a wall thickness 10 of the component 1 at the first end E1 is greater than the wall thickness 10′ of the component at the second end E2.

FIG. 12 shows an X-ray image of a component with an elongated fibre bundle. The component should preferably have at least 20% of the fibre bundles in areas that are not already determined to be curved by the predetermined component geometry, which deviate from this by a maximum of 5 mm (preferably by 2 mm) compared to an applied straight line. Curvatures in the fibre bundles that do not result from the preform production, but rather from the geometry of the component, which are forced and desired dimensions, are determined by using the closest component edge as a reference.

### EXAMPLE 1

For Example 1, a body according to an exemplary embodiment of the invention was produced as a crash component, as shown in FIG. 2a. For the test result, the component was tested in a dynamic impact test. For this purpose, preforms were first produced. For this step, a carbon fibre yarn (Tenax HTS 40 X 030 12k 800 tex) with obstructions (according to the documents WO 2005/095080, WO 2013/017434) was cut into fibre bundles in the transverse and longitudinal directions. The fibre bundles were given a length of 50 mm and a width between 1 mm and 5 mm. These fibre bundles were formed into preforms close to the final contour. For this purpose, the fibre bundles are applied to a preform tool, which already largely depicts the geometry of the end component. The method of application (manually or by means of a regulated moving unit, for example a robot) is of subordinate importance as long as a uniform application of the bundles is generated. In the example, a fibre application is set which leads to a fibre volume content in the component of 50 vol. % with a maximum deviation of ±5 vol. %. In order to fix the fibre bundles at the respective application location, the preform tool can be designed with many small holes which are subjected to a suction flow. In this way, the fibre bundles are suctioned in and fixed at the respective point. In the next step, this structure is heated and the binder develops its adhesive effect. Under certain circumstances, the structure can be compacted by an additional force perpendicular to the respective surface. After the binder has cooled down again, the entire preform but also the individual fibre bundles are fixed in their local locations. The preforms were made in a steel tool using a resin infusion process (resin transfer moulding, RTM) to form two half-shell-shaped profile components (partial bodies) with a constant wall thickness of 2 mm in the longitudinal direction and a partially semicircular cross section. The fibre volume fraction of the partial bodies was 50%. An epoxy resin system (Huntsman Araldite LY 1564/Aradur AD 22962) was used as the matrix system for the resin infusion. After the demoulding of the profile components or the partial bodies, they were annealed. The partial bodies were trimmed with a diamond circular saw. Two of these half-shell-shaped partial bodies were joined together in an adhesive clamp and glued to flat longitudinal flanges with a two-component onstruction adhesive (3M DP490). Subsequently, a force introduction structure (so-called trigger) in the form of a circumferential 45° chamfer was introduced on one side of the component.

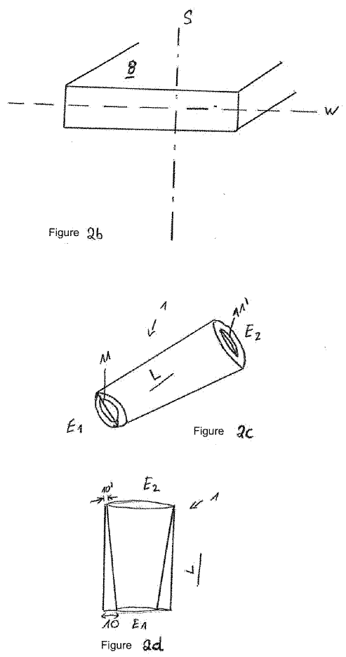

The component manufactured in this way was attached to a flat, non-compliant baffle plate made of steel, so that the longitudinal axis was perpendicular to the plate and the force application point was facing outwards. Subsequently, a carriage, which had a mass of 61 kg and a flat steel baffle plate in the direction of the component, was driven onto the component at 10 m/s in such a way that it was destroyed along its longitudinal axis. During the destruction process, the path of the carriage in the event of an impact was absorbed with a magnetic displacement sensor and a magnetostrictive position measurement system (Temposonics R-Series of the Fa. MTS with max. 1000 mm path length) and the force acting on the component was absorbed with a load cell (Piezo-KMD 9091A from Kistler with a max. 400 kN) on the component. A course of the force and the path over time was recorded with a sampling period of 4 ps and frequency of 250 kHz. In FIG. 3, the recorded force-displacement relationship of the various components is shown averaged (X-axis displacement in mm, Y-axis force in kN), wherein both the displacement and the force data were filtered numerically in terms of time using a Channel Frequency Classes (CFC) 600 filter algorithm (according to SAE J211). A force plateau at (50 +/− 5) kN was shown in this curve. The absorbed energy per mass of the component material (dissipated energy density) was 71 J/g. The result showed that in the failure zone initiated by the trigger, the impact energy from the continuously acting impact force was dissipated by converting it into degradation energy to create the new surfaces between fibre and matrix. Due to the largely time-constant course of the failure zone, a uniform course of the failure force and the associated uniform energy consumption was created. There are no large fluctuations in amplitude, which lead to a hazard to, for example, vehicle occupants. The value of the dissipated energy density was within the range of the values of other materials which represent the prior art, or exceeded them, as shown in Table 1.

| Material: | dissipated energy density in J/g |
|---|---|
| Example 1, 50 mm | 71 |
| Cut length | |
| Comparative Example 1, | 75 |
| Thermoplastic CF-PA6 | |
| Comparative Example 2, | 42 |
| aluminium | |

Comparative Example 1 from Table 1 is a component made of carbon fibres with a cut length of 50 mm, wherein the component is produced as described in Example 1, with the difference that polyamide 6 was used as the matrix material. As explained in relation to FIG. 1, such a component has the disadvantage that the initial amplitude is significantly higher than for a component according to an exemplary embodiment of the invention. In addition, thermoplastic matrix systems show temperature-dependent crash behaviour, which is not desirable. In addition, components with a high portion of thermoplastics tend to absorb water, which reduces the lifespan of such components by swelling of the components. It is easy to see that the shortening of the service life, especially at the end of the life cycle, influences and reduces the crash properties of the component. The temperature dependence of components with a thermoplastic matrix is shown in FIG. 11.

The X axis of FIG. 11 describes the path in mm, the Y axis describes the force in kN. Curve

D describes the crash behaviour of a component constructed according to Comparative Example 1 at −30° C. Curve E describes the crash behaviour of a component constructed according to Comparative Example 1 at −20° C., the F curve at 50° C. and the G curve at 90° C. Such a temperature range is particularly common in the case of components as crash elements in the automotive sector. Consistent failure behaviour, which is largely independent of the temperature, can therefore not be achieved with thermoplastics as the main matrix material.

Comparative Example 2 from Table 1 is an aluminium tube, as was also used for the experiment in FIG. 1.

### EXAMPLE 2

As described in Example 1, a component was produced from preforms which contained fibre bundles 25 mm long and 1 mm to 5 mm wide. In contrast to Example 1, fibre lengths of 25 mm were used instead of 50 mm. The wall thickness of the component corresponded to that of Example 1. The component was destroyed as indicated in Example 1. This resulted in a force curve similar to that shown in FIG. 3 with a force plateau at (55 +/− 5) kN. The absorbed energy per mass of the component material was 72 J/g. The course of the force-displacement curve and the specific energy density did not differ significantly from the case in Example 1 with a cut length of 50 mm. A separate figure for example 2 was therefore not created.

### EXAMPLE 3

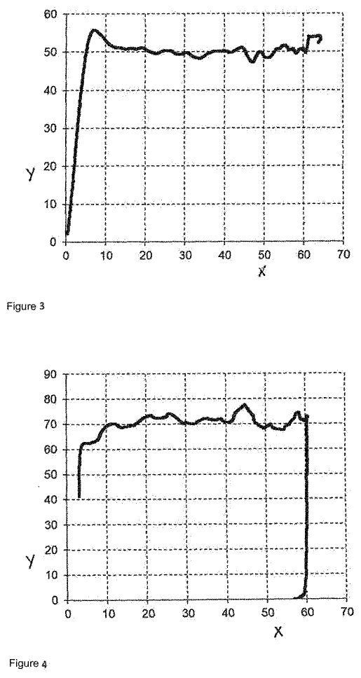

As described in Example 1, components were produced from preforms which contained fibre bundles 50 mm long and 1 mm to 5 mm wide. In contrast to Example 1, however, two components were manufactured that had a wall thickness of 3 mm or 4 mm. The components were destroyed as indicated in Example 1 and the results worked up as indicated for Example 1. This resulted in a force curve as in FIG. 4 for the component with 3 mm wall thickness and in FIG. 5 for the component with 4 mm wall thickness with a force plateau at (70 +/− 5) kN for 3 mm wall thickness and (90 +/− 7) kN for 4 mm wall thickness. The absorbed energy per mass of the component material was 70 J/g for 3 mm wall thickness and 73 J/g for 4 mm wall thickness. This showed that the failure force was adjustable through the wall thickness of the component and scaled largely linearly with the cross-sectional area of the wall, whereby the dissipated energy density remained largely constant. An adjustable force curve is thus advantageously possible during the deformation of the component.

### EXAMPLE 4

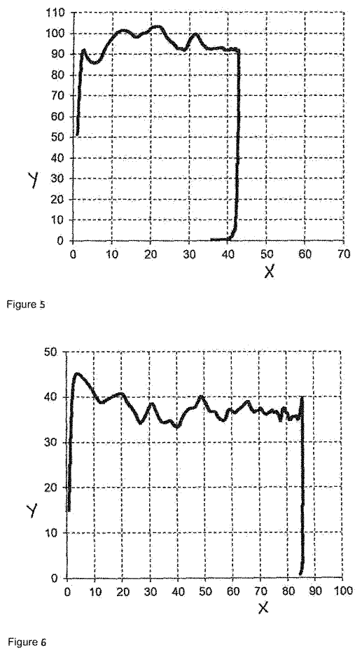

As described in Example 1, components were produced from preforms which contained fibre bundles with a length of 50 mm and a width of 1 mm to 5 mm and a wall thickness of 2 mm. The components were destroyed as indicated in Example 1 and the data were processed as indicated for Example 1. Unlike in Example 1, however, the components were tempered to −30° C., 70° C. and 110° C. up to 30 s before the tests. This resulted in component temperatures of −30° C., 50° C. and 90° C. in the crash test. The force curves shown here resulted in the curves in FIG. 6 (−30° C.), FIG. 7 (50° C.) and FIG. 8 (90° C.) with a force plateau at (40 +/− 5) kN for a component temperature of −30° C., (45 +/− 5) kN for a component temperature of 50° C., and (45 +/− 5) kN for a component temperature of 90° C. The absorbed energy per mass of the component material was 54 J/g for a component temperature of −30° C., 60 J/g for a component temperature of 50° C., and 60 J/g for a component temperature of 90° C. It turned out to be advantageous that the temperature dependence of the failure force and the dissipated energy density is not very pronounced. This was particularly evident in comparison to carbon fibre composite materials with thermoplastics, as can be found in the prior art and as they were investigated in Comparative Example 1, FIG. 11.

### EXAMPLE 5

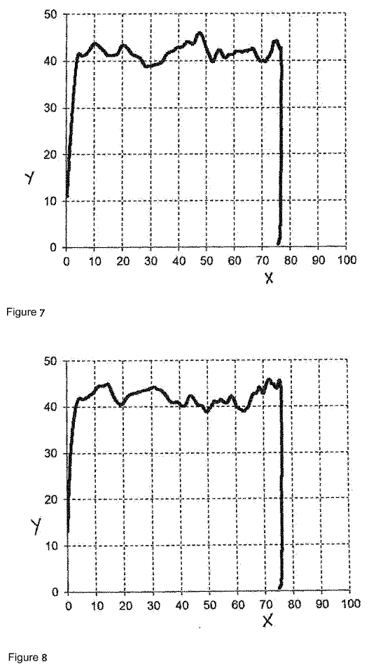

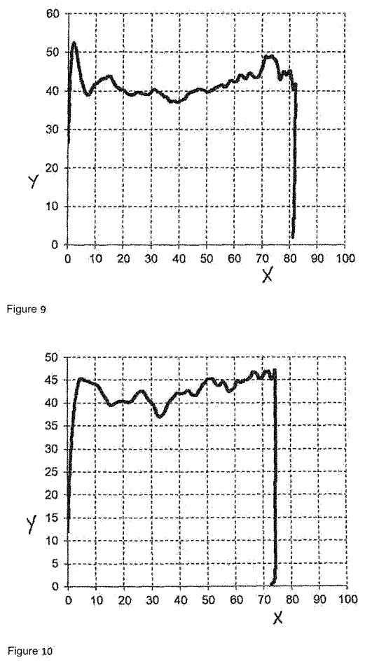

As described in Example 1, components were produced from preforms which had fibre bundles 50 mm long and 1 mm to 5 mm wide with a wall thickness of 2 mm. However, the fibre volume fraction of the components according to Example 5 was once 40% and once 45%. The components were destroyed as indicated in Example 1 and the data prepared as described in Example 1. This resulted in the force curves of the curves shown in FIG. 9 for 40% fibre volume fraction and FIG. 10 with 45% fibre volume fraction with a force plateau at (45 +/− 10) kN for a fibre volume fraction of 40% and at (45 +/− 5) kN for a fibre volume fraction of 45%. The absorbed energy per mass of the component material was 64 J/g for a fibre volume fraction of 40% and 61 J/g for a fibre volume fraction of 45%. While the fluctuations in the plateau area of the force-displacement curve were still relatively large with a fibre volume fraction of 40%, a relatively flat plateau was already formed at 45%. So here the advantageous failure of the material took place. The respectively higher force level of the plateau value of the test with a fibre volume content of 50% from Example 1 in comparison with the value at 45% and in comparison with the value at 40% fibre volume fraction showed that a smaller fibre volume fraction reduced the failure properties (force and dissipated energy density), since there were fewer detachment processes between fibre and matrix material per component volume.

### LIST OF REFERENCE NUMERALS

A Curve component aluminium
B Curve component carbon fibres with thermoplastic
C Curve component according to an embodiment of the invention
D Curve Comparative Example component with thermoplastic
E Curve Comparative Example component with thermoplastic
F Curve Comparative Example component with thermoplastic
G Curve Comparative Example component with thermoplastic
1 Component (impact element, crash structure)
2 Rib
3 Recess/hole
4Corrugated profile
5 Lid/flap
6 Flange
7 Semicircular profile
8 First surface
9 Second surface
10, 10′ Wall thickness
11 Outer cross section
11′ Inner cross section
E1 First end
E2 Second end
L Longitudinal direction
S Perpendicular to surface 8, 9
W Parallel to surface 8, 9

1. Three-dimensional body-shaped component formed from a fibre composite material based on carbon fibres for arrangement between a first impact element and a second impact element and for absorbing impact energy as a result of an impact load acting between the first impact element and the second impact element, which has an impact direction, p1 the component comprising:
at least a first end and a second end,
a longitudinal direction extending between the ends, which is arranged substantially in the impact direction,
a first surface and a second surface and a wall with a wall thickness extending between the first surface and the second surface,
wherein the wall is constructed at least predominantly from bundles of carbon fibres, within which the carbon fibre filaments which form the carbon fibres are arranged parallel to one another,
wherein the bundles and the carbon fibres making up the bundles are embedded in a polymer matrix, which predominantly comprises one or more crosslinked polymers,
wherein the bundles are distributed substantially uniformly over the wall thickness, when viewed in a direction perpendicular to the first surface and/or the second surface are oriented substantially isotropically, and when viewed parallel to the first and/or second surface the bundles form intersection angles with a part of the first surface and/or the second surface, wherein the bundles, viewed parallel to the first surface and/or the second surface, are distributed within the component so that the predominant portion of the intersection angles lie in a range in which the intersection angles are substantially distributed between 0° and 90° up to predominantly existing intersection angles greater than 1°,
wherein a fibre volume fraction of the carbon fibres in the wall is between 35 vol. % and 70 vol. %,
wherein the bundles of carbon fibres have a length between 3 mm and 100 mm and
wherein the component is obtainable by a method comprising the production of a fibre preform from the bundles of carbon fibres, and by subsequently introducing a matrix system into the fibre preform by injection, infusion, infiltration or pressing and crosslinking the matrix system, wherein the matrix system consists substantially of one or more crosslinked polymers.

2. Component according to claim 1, wherein the carbon fibres are stretched in the wall when viewed perpendicular to the first and/or second surface.

3. Component according to claim 1, wherein the fracture toughness of the polymer matrix changes by a maximum of 100% when the temperature changes from 20° C. to 100° C. measured according to ISO13586.

4. Component according to claim 1, wherein the inner and/or the outer cross section of the body has a corrugated shape, a zig-zag shape, an angular shape, a curve or mixtures of the forms mentioned above.

5. Component according to claim 1, wherein the component has a closed or open hollow profile as a body, which has an interior space extending between the first and second ends, wherein the first end and the second end are connectable to the first and second impact elements, and wherein the body has an outer cross section and an inner cross section and the first surface faces away from the interior space and the second surface faces toward the interior space.

6. Component according to claim 5, wherein the inner cross section and/or the outer cross section has a circular, elliptical, square or rectangular contour or a polygonal contour.

7. Component according to claim 5, wherein the inner cross section and/or the outer cross section is constant along the extension in the longitudinal direction.

8. Component according to claim 5, wherein the inner cross section and/or the outer cross section increases in an area between the first end and the second end from the first to the second end of the composite material component.

9. Component according to claim 1, wherein the wall thickness increases in an area between the first end and the second end from the first end to the second end of the component.

10. Component according to claim 1, wherein the polymer matrix, which embeds the bundles of carbon fibres and/or the matrix system, is a duromeric resin.

11. Component according to claim 1, wherein the component has at the first end an area for introducing the impact energy.

12. Component according to claim 1, wherein the component is constructed from two partial bodies which are connected to one another in the longitudinal direction to form the component.

13. Component according to claim 12, wherein the partial bodies have flanges laterally in the longitudinal extension, by which the partial bodies are connected to one another.

14. Component according to claim 1, wherein the wall on the first surface and/or the second surface has reinforcing elements which extend in the longitudinal direction of the component.

15. Component according to claim 1, wherein the wall further comprises at least one layer of unidirectionally oriented long fibres, wherein the at least one layer is arranged on at least one of the surfaces or in the interior of the wall and extends between the first end and the second end of the component.

16. Component according to claim 1, wherein the fibre volume fraction of the carbon fibres in the wall is from 45 vol. % to 65 vol. %.

17. Component according to claim 1, wherein the carbon fibres have a length of 5 mm and to 70 mm.
